(19) United States
(12) Patent Application Publication
(10) Pub. No.: US 2026/0187215 A1
(43) Pub. Date: Jul. 2, 2026

(54) PROTECTION FOR ELECTRONIC COMMUNICATIONS

(71) Applicant: GetReal Security, Inc., Austin, TX (US)

(72) Inventors: Senthil Periaswamy, Hollis, NH (US); Hany Farid, Berkeley, CA (US); Matt Moynahan, Gloucester, MA (US); James Brennan, Atlanta, GA (US)

(21) Appl. No.: 19/428,911

(22) Filed: Dec. 22, 2025

Related U.S. Application Data
(60) Provisional application No. 63/739,842, filed on Dec. 30, 2024.

(51) Int. Cl. G06F 21/32; G06T 7/70; G06V 40/40; H04N 7/15

(52) U.S. Cl. CPC G06F 21/32; G06T 7/70; G06V 40/40; H04N 7/152; G06T 2207/30201

(57) ABSTRACT

A method includes acquiring a first video stream including a first instance of a user from a first video meeting, determining that the user is not modified, and creating a reference record for the user that includes a face biometric reference signature. The method includes acquiring subsequent video streams and updating the reference record to include an additional reference signature for the user. The method includes, during a current video stream, detecting a face biometric event if a current face biometric signature for the user deviates from the face biometric reference signature and detecting an additional event if a current additional signature for the user deviates from the additional reference signature. The method includes providing a response to a security analyst based on whether the face biometric event and the additional event were detected, wherein the response is selected from a table that maps responses to events.

### CROSS-REFERENCE TO RELATED APPLICATION

This application claims the benefit of U.S. Provisional Application No. 63/739,842, filed on Dec. 30, 2024. The disclosure of the above application is incorporated herein by reference in its entirety.

### FIELD

The present disclosure relates to providing identity protection for electronic communications.

### BACKGROUND

Video media and technology has become integral to personal and professional communication, entertainment, and e-commerce. In business, videoconferencing allows employees to collaborate in real time, regardless of location. Online education and telemedicine have also adopted video technology, enabling students to learn remotely and patients to consult healthcare providers from their homes. Meanwhile, social media platforms have fueled a creator economy, where individuals can leverage video to build personal brands, attract followers, and generate revenue through sponsorships and advertising.

The convergence of technology and economic opportunity has transformed video into a powerful tool for both personal expression and revenue generation, reshaping how people connect, learn, and conduct business. As video technology grows in economic and social significance, maintaining the integrity and trustworthiness of content has become increasingly important. The rise of artificial intelligence (AI) driven synthetic media, which may be referred to in some instances as “deepfakes,” presents threats to individuals and organizations that rely on video content. For businesses, deepfakes pose financial and reputational risks. In the media and political spheres, deepfakes have the potential to spread misinformation at scale, eroding public confidence and compromising the integrity of information.

### SUMMARY

In one example, a method comprises acquiring, at a server, a first video stream including a first instance of a first user from a first video meeting with a plurality of additional users. The method further comprises determining that the first user in the first instance has not been modified in the first video stream. The method further comprises creating a reference data record for the first user that includes a face biometric reference signature extracted from the first video stream, wherein the face biometric reference signature indicates features of the first user's face. The method further comprises acquiring one or more subsequent video streams from a plurality of subsequent video meetings including subsequent instances of the first user and updating the reference data record to include an additional reference signature for the first user extracted from audio data and video data in the first video stream and one or more of the subsequent video streams. The method further comprises, during a current video stream for a current video meeting including a current instance of the first user, detecting a face biometric event if a current face biometric signature for the current instance of the first user deviates from the face biometric reference signature and detecting an additional event if a current additional signature for the current instance of the first user deviates from the additional reference signature. The method further comprises providing a first response to a security analyst device based on whether the face biometric event was detected and based on whether the additional event was detected, wherein the first response is selected from a table that maps one or more responses to a set of one or more different events.

In one example, a system comprises one or more storage devices configured to store a reference data record for a first user. The system further comprises one or more processing units configured to execute computer-readable instructions that cause the one or more processing units to acquire a first video stream including a first instance of the first user from a first video meeting with a plurality of additional users, determine that the first user in the first instance has not been modified in the first video stream, and extract a face biometric reference signature from the first video stream, wherein the face biometric reference signature indicates features of the first user's face. The one or more processing units are configured to store the face biometric reference signature in the reference data record, acquire one or more subsequent video streams from a plurality of subsequent video meetings including subsequent instances of the first user, and update the reference data record to include an additional reference signature for the first user extracted from audio data and video data in the first video stream and one or more of the subsequent video streams. During a current video stream for a current video meeting including a current instance of the first user, the one or more processing units are configured to detect a face biometric event if a current face biometric signature for the current instance of the first user deviates from the face biometric reference signature and detect an additional event if a current additional signature for the current instance of the first user deviates from the additional reference signature. The one or more processing units are configured to provide a first response to a security analyst device based on whether the face biometric event was detected and based on whether the additional event was detected, wherein the first response is selected from a table that maps one or more responses to a set of one or more different events.

### BRIEF DESCRIPTION OF THE DRAWINGS

The present disclosure will become more fully understood from the detailed description and the accompanying drawings.

FIGS. 1A-1B illustrate example environments that include an identity protection system.

FIG. 2 illustrates communication session data transfer and a communication session graphical user interface (GUI) during a communication session between two users.

FIG. 3 illustrates a method that describes operation of the environment of FIG. 1A.

FIGS. 4A-4D illustrate an example data acquisition system and example data that may be acquired and stored by the data acquisition system.

FIGS. 5-6 illustrate an example analysis and detection system.

FIG. 7 illustrates example data generated for a user over a plurality of communication sessions.

FIG. 8 illustrates an example response system.

FIG. 9 illustrates a method that describes example operation of the identity protection system during a video meeting that includes a plurality of participants.

FIG. 10 illustrates an example signature extraction GUI and process.

In the drawings, reference numbers may be reused to identify similar and/or identical elements.

### DETAILED DESCRIPTION

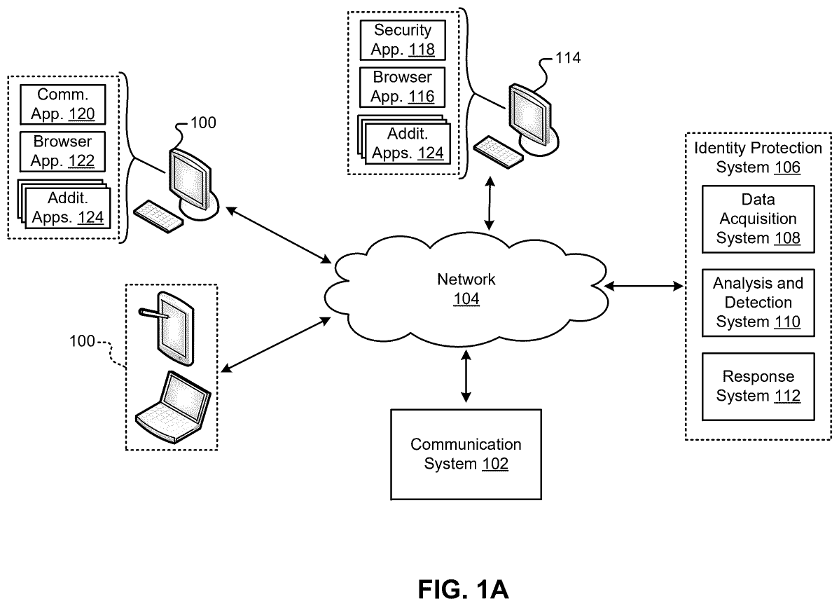

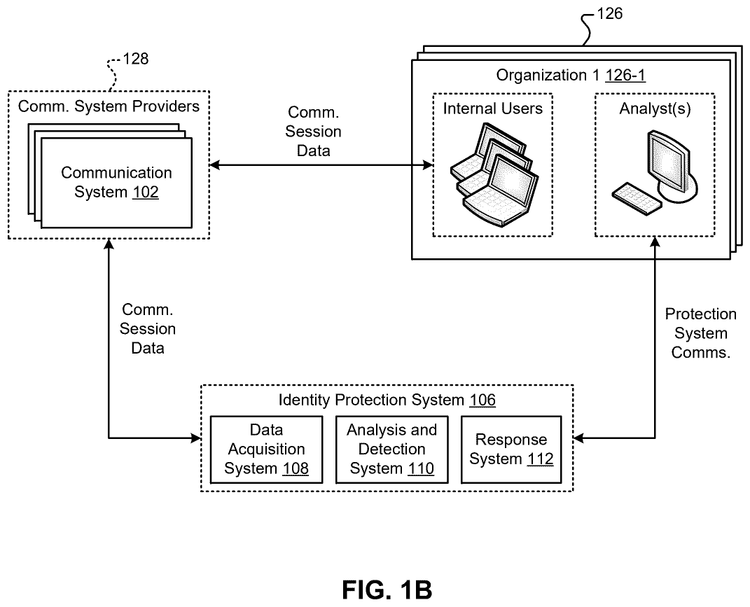

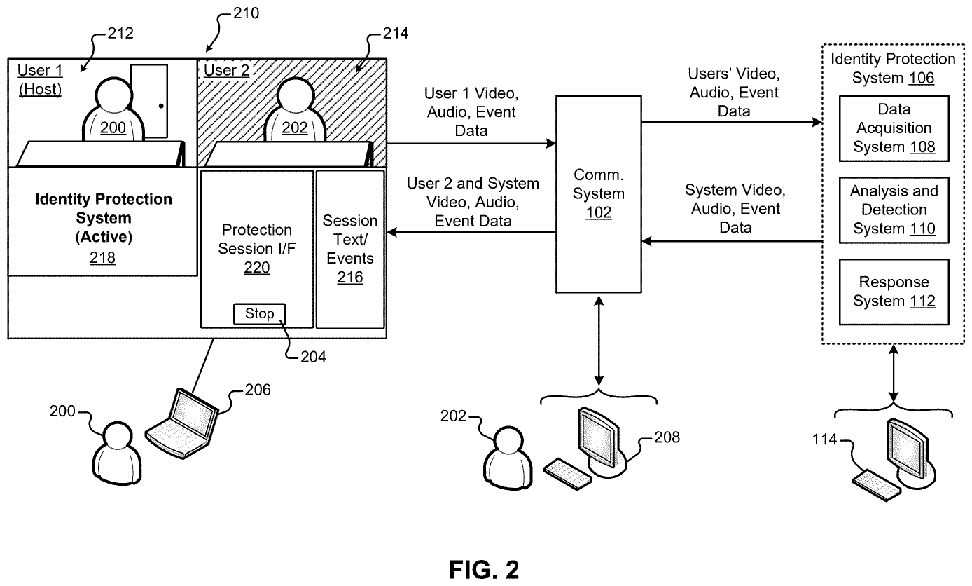

FIG. 1A illustrates an environment in which a plurality of users may use their computing devices 100 (“user devices 100”) to communicate with one another via a remote communication system 102. The communication system 102 may include one or more remote servers that host a communication session (e.g., a video meeting) between the users (e.g., see FIG. 2). For example, the communication system 102 may host audio and/or video communication sessions between users that are using mobile computing devices and desktop computing devices. The devices and systems described herein may communicate via a network 104. The network 104 may include various types of networks, such as a local area network (LAN), wide area network (WAN), and/or the Internet.

A communication session may refer to a period of time during which audio, video, and/or other communications (e.g., text communications) occur between two or more users. For example, a communication session may occur between one or more human users and one or more computer-generated users. In some cases, a communication session including only audio communications may be referred to as an “audio communication session.” For example, a voice over Internet Protocol (VOIP) session may include only audio communications. Communication sessions that include video and audio may be referred to as “video communication sessions.” Although a period of time including video and/or audio communications may be referred to as a communication session, in some cases, a communication session may be referred to as a “meeting,” a “conference,” a “call,” or other term that may generally be used to describe an interaction between two or more users. For example, a video communication session between users may be referred to herein as a “video meeting.”

An identity protection system 106 (“protection system 106”) may protect the identities of users in communication sessions by detecting modifications to the communication sessions, such as modifications to a user's face and/or environment (e.g., a user's background). In some implementations, the protection system 106 may extract reference signatures (e.g., biometric signatures) for users based on prior communication sessions including the users. Using the reference signatures, the protection system 106 may detect an imposter in future communication sessions by detecting mismatches between imposter signatures and the stored reference signatures for the real user. The protection system 106 may also detect other scenarios that may be of interest to security analysts or meeting participants, such as the presence of known bad actors in communication sessions.

The protection system 106 includes a data acquisition system 108, an analysis and detection system 110 (“detection system 110”), and a response system 112. The data acquisition system 108 may acquire data associated with communication sessions between users. For example, the data acquisition system 108 may acquire video and audio data streamed by users during a video communication session (e.g., see FIG. 2).

The data acquisition system 108 may also store various user signatures that are measured by the detection system 110 based on video and audio data acquired during a communication session. Example signatures may include, but are not limited to, user face biometric signatures, user voice biometric signatures, user behavioral mannerism signatures (behavioral signatures), user language pattern signatures, and/or user environmental signatures. The data acquisition system 108 may store data associated with a user (e.g., signatures and other data) per-instance of the user in a communication session. The data acquisition system 108 may also store reference signatures for the user that may be measured over a plurality of communication sessions. A new instance of a user in a communication session may be compared against the user's stored reference signatures to determine whether the new instance of the user is who they claim to be.

The detection system 110, in communication with the response system 112, may detect a variety of events that may occur during communication sessions. For example, the detection system 110 may detect one or more modifications to video data and audio data associated with one or more users during a video communication session. Example modifications may include face modifications (e.g., a face swap modification), environmental background modifications, and voice modifications. The detection system 110 may also detect when a user's signatures in a current meeting deviate from their past signatures, as represented by a user's stored reference signatures. In a specific example, the detection system 110 may determine that a user could be an imposter based on deviations in at least one of the user's face biometric signatures and voice biometric signatures. In some implementations, the detection system 110 may also determine whether any of the users in a communication session is a known bad actor. The events detected by the detection system 110 may be referred to herein as “detection events.”

The response system 112 may respond to the various detections made by the detection system 110. Example responses may include notifying a security analyst, a meeting host, or other participant(s) of the detection. Other example responses may include removing a user associated with the detection event(s) or stopping the communication session entirely.

The response system 112 may also provide an analyst interface for a security analyst to use in order to analyze the communication session in which the detection events are occurring or have occurred. For example, the analyst interface may insert the analyst in the communication session in real-time (e.g., during the meeting). As another example, the analyst interface may provide video and audio from the communication session for analysis after the communication session concludes. In some cases, the analyst interface may include dashboards, reports, or other interfaces for analyzing meeting details, participants, and other relevant information related to the detection events. In some cases, the response system 112 may also log data associated with the meetings, participants, and detection events in the data acquisition system 108.

The protection system 106 can protect users'identities in a variety of ways using combinations of various techniques. For example, the protection system 106 can protect users from imposters that impersonate others and/or hide their identities using video/audio modifications (e.g., deepfakes). Automatically detecting such imposters and other bad actors, as well as providing automatic alerts/responses and analyst investigation features may help protect users and their organization in a variety of ways described herein.

In some examples, using modification detection techniques, the protection system 106 may detect a human user that has modified their appearance in a video meeting to some extent (e.g., a face modification) in order to lead others in the video meeting to believe that they are someone else. For example, the modified user may intend to hide their own identity or steal the identity of another user. In the case where an imposter is modifying their own face to appear as another individual with signatures stored in the protection system 106, the protection system 106 may identify the user that is having their identity substituted for the imposter (e.g., by finding matching face biometric signatures). In addition to detecting local modifications in a video stream (e.g., face modifications), the protection system 106 may be configured to detect completely synthetic computer-generated media (e.g., a completely synthetic video stream without a live human user). The protection system 106 may also detect audio modifications to a user's voice in some implementations.

In some examples, the protection system 106 may detect a human imposter, absent video modifications, based on deviations between the imposter and the impersonated user's stored reference signatures. In this case, the imposter may be attempting to impersonate the user without additional technical modifications to their video and audio. In some cases, the imposter may be attempting to impersonate another person in their organization. In other cases, such as fraud during a job hiring process, multiple different users may interview as the same person for a single job in order to secure the job. Additionally, or alternatively, after a person is hired for a job, a different person may show up to work than the person/people that were originally interviewed for the job.

In some implementations, the protection system 106 may identify when a user has modified a portion of their environment (e.g., their background), or all of their environment, in the video stream. Although environmental modifications (e.g., background blur) may be typical during video meetings, in some cases, environmental modifications may be used as evidence that the user is hiding their location or other identifying features of their environment.

In some implementations, the protection system 106 may be configured to detect other types of nefarious activities. For example, the protection system 106 may identify known bad actors by matching a user's face biometrics and/or voice biometrics to a database of known bad actors, such as known criminals, state actors, or others. As another example, the protection system 106 may be configured to detect additional evidence of suspicious behavior, such as suspicious IP addresses, suspicious email addresses, inconsistencies in IP address and reported location, computer/camera inconsistencies, or other data.

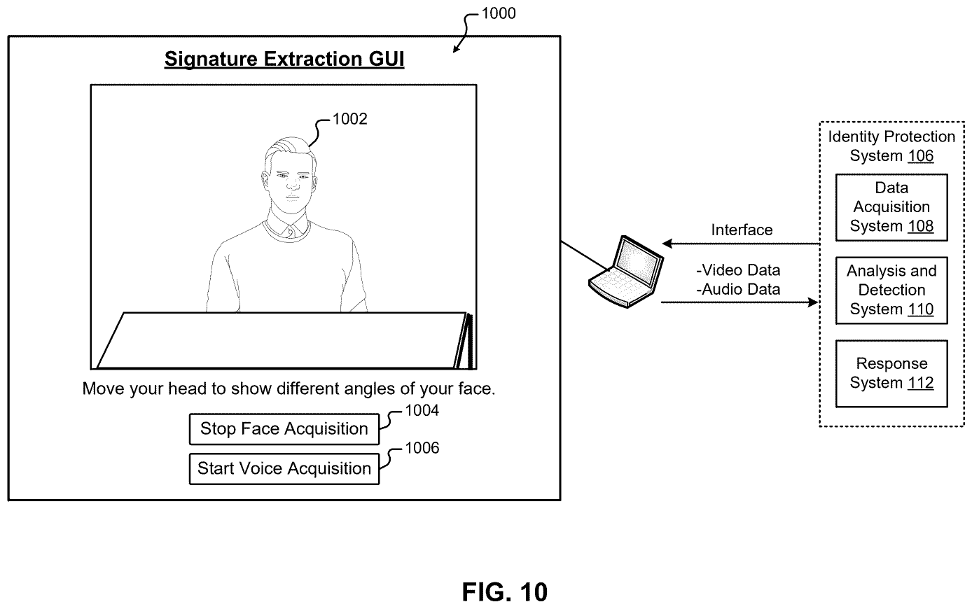

The protection system 106 may extract signatures during communication sessions and make reference signatures for users passively during one or more communication sessions. The passive generation of reference signatures may not require the users to intentionally perform any specific poses, movements, or verbal recitations during communication sessions. For example, the protection system 106 may operate in the background and be unnoticeable while a communication session occurs, thereby providing convenient identity protection for communication session participants. Although the protection system 106 may operate in a passive manner in some implementations, in other implementations, the protection system 106 may include a separate interface for acquiring a user's reference signatures and/or verifying a user's identity. An example separate interface and set of procedures is illustrated and described with respect to FIG. 10.

Although multiple human users may communicate with one another in a communication session, features of the protection system 106 may be implemented in communication sessions including a single human user and a single computer-generated user (e.g., synthetic video, audio, and/or text). Additionally, in some implementations, the features of the protection system 106 may be implemented for video and/or audio including a single user in a video or audio file that has been transmitted, such as a video message or a voice message.

In some implementations, the techniques described herein may be implemented in real-time (e.g., during a communication session). In some implementations, the techniques described herein may be implemented for recorded communication sessions, such as communication sessions that have ended, but were recorded for later analysis (e.g., recorded audio, video, text, events, etc.). Although the techniques may be implemented for sessions involving communication between human and/or synthetic participants, in some implementations, the techniques of the present disclosure may be used to analyze audio and/or video files that are not part of a typical communication session between multiple participants, such as a recorded voice message or video.

Referring to FIG. 1A, the environment includes a security analyst device 114 (“analyst device 114”). A security analyst may interact with the protection system 106 using the analyst device 114. The analyst device 114 may interface with the protection system via a web browser 116 and/or a security application 118 dedicated to interacting with the protection system 106. A variety of interactions between the analyst device 114 and the protection system 106 are described herein. For example, the protection system 106 may provide dashboards/reports associated with detection events. As another example, the protection system 106 may provide functionality for intervening with current meetings and/or reviewing completed meetings. As another example, the protection system 106 may receive input from the analyst device 114 regarding assessments made by the analyst regarding specific detections. Although a security analyst is described herein as an individual that may handle matters related the protection system 106 (e.g., notifications, meeting interventions/reviews, etc.), other personnel within an organization may handle the tasks associated with the security analyst.

Each user may use one or more devices 100 during a communication session. Example user devices 100 may include mobile devices, such as smartphones, tablets and/or laptops. User devices 100 may also include desktop computers, telepresence systems, or other more stationary devices. In some cases, user devices 100 (e.g., a laptop) may include an integrated camera and microphone. In other cases, a user device 100 may be connected to an external camera (e.g., a webcam) and/or external microphone. In some implementations, user devices 100 may execute applications (e.g., communication applications 120) for participating in a communication session. In other implementations, user devices may participate in a communication session using a web browser application 122. Although a single user may participate in a communication session using a single user device, in some cases, two or more users may use the same user device to participate in a communication session with other additional users.

A computing device (e.g., user device 100 and analyst device 114) described herein can execute computer-readable instructions in memory. For example, a user device 100 and analyst device 114 can include one or more processing units that can execute the communication application 120, security application 118, an operating system, a web browser application 116, 122, and additional applications 124, all of which can be implemented as computer-executable instructions. A user device 100 and analyst device 114 can include one or more computer-readable mediums (e.g., random-access memory, hard disk drives, solid state memory drives, etc.) that can store any suitable data that is utilized by the operating system and/or any of the applications that are executed by the devices 100, 114.

The communication system 102 may include one or more remote servers that host communication sessions between participants. Hosting the communication sessions may include handling the transfer of video, audio, and other data between the session participants. Hosting may also include handling scheduling of the sessions. Example communication sessions may include audio only communication sessions, such as VOIP, call centers, etc. Example communication sessions may also include video communication sessions, such as videoconferencing. Example communication systems and providers may include the videoconferencing application ZOOM® provided by Zoom Communications, Inc., MICROSOFT TEAMS® videoconferencing provided by Microsoft Corporation, and WEBEX® videoconferencing provided by Cisco Technology, Inc.

The systems and devices described herein may be operated by a variety of different parties (e.g., users and businesses). FIG. 1B illustrates an example configuration of the environment of FIG. 1A in which a plurality of organizations 126 (e.g., businesses or other organizations) use one or more communication system providers 128 for hosting communication sessions. In FIG. 1B, the protection system 106 is operated by another party (e.g., a business) that provides identity protection for the plurality of organizations 126. In the arrangement of FIG. 1B, the organizations 126 (e.g., organization 1 126-1) may include employees (e.g., internal users and analysts) that interact with the communication systems (e.g., communication system 102) and the protection system 106. The organizations'internal users may engage in communication sessions with one another or with external users using any of the communication systems. The analyst(s) for an organization may be employees that are tasked with cybersecurity duties, such as configuring operation of the protection system 106 and responding to detection events provided by the protection system 106.

The systems and devices of FIG. 1A may be operated in different manners than illustrated in FIG. 1B. For example, in some cases, a communication system provider may also own and operate the protection system 106 in order to provide identity protection for its users. In another example, some of the protection system features may be internally implemented by an organization (e.g., a business). For example, an organization (e.g., a business) may store their protection system data locally within the organization and have the data processed by another party that owns and operates the other features of the protection system. Although various configurations of the environment of FIG. 1A are illustrated and described herein, the techniques of the present disclosure may be applied in other environments including other arrangements of systems and devices.

In some implementations, protection system data described herein (e.g., reference records, instance records, etc.) may be shared across multiple organizations. For example, the protection system 106, whether implemented by a single party or multiple parties, may store data for a plurality of organizations, or otherwise access data across multiple organizations. For example, a first organization (e.g., a first protection system) may acquire data from a second organization (e.g., a second protection system) for processing. In a specific example, the first organization may acquire reference records for users that are part of the second organization, but not part of the first organization. This may allow the first organization to identify a malicious actor that operates in a fraudulent manner across organizations, such as a single individual that is employed by two organizations. Additionally, a first organization may detect malicious actors and provide the malicious actor data to a second organization so that the second organization can identify the malicious actors if the malicious actors attempt to interact with the second organization.

FIG. 2 illustrates a communication session between two users 200, 202. Users involved in a communication session may also be referred to as “participants” in the communication session. Although communication sessions may include all human participants, in some implementations, a communication session may include one or more computer-generated participants that have their video and/or audio generated by computer (e.g., generated/edited using artificial intelligence). In some cases, a communication session may include a host participant, referred to also as a “host.” In some implementations, a host may control whether the protection system 106 is active during the communication session. For example, the host may interact with a Start graphical user interface (GUI) element or a Stop GUI element (e.g., stop GUI element 204) that starts or stops the protection system 106 during the communication session.

In some implementations, a communication session may be organized by a communication session organizer that may or may not participate in the session as a session participant. In some cases, a host may organize the meeting and moderate the meeting. Organizing a communication session may include selecting participants, selecting a time, sending emails or other communications to participants with calendar invites, providing a description for the meeting, selecting one or more physical locations for the meeting, and/or additional tasks. In some implementations, the communication system hosting the communication session may store the meeting organization details and provide reminders to the participants.

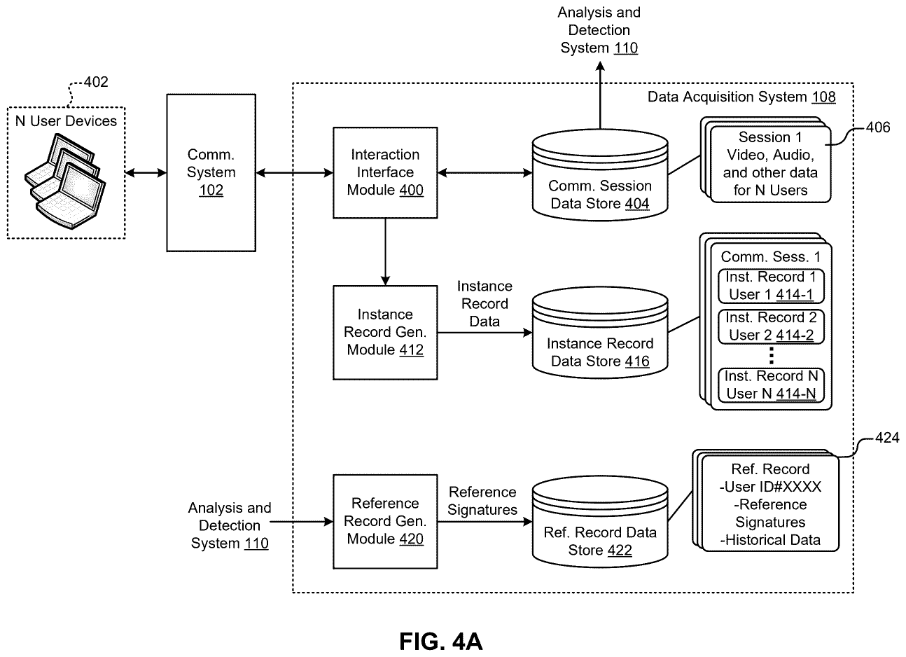

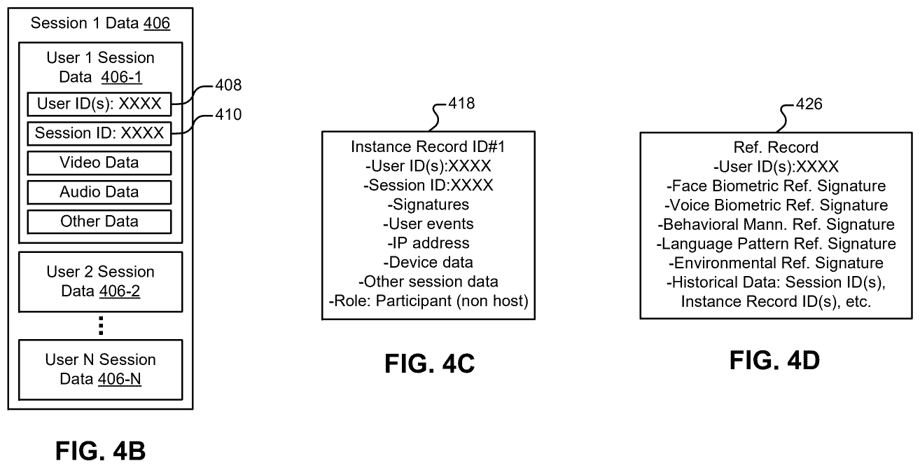

In FIG. 2, two users 200, 202 are engaged in a communication session (e.g., a video meeting) that is being analyzed by the protection system 106. User 1 200 and User 2 202 are using device 1 206 and device 2 208, respectively. In FIG. 2, User 1 200 is acting as the communication session host. The protection system 106 (e.g., interaction interface module 400 of FIG. 4A) is acting as a third participant in the communication session. For example, the protection system 106 may acquire data during the communication session and interact with other users 200, 202 during the communication session. The data transfers between the user devices 206, 208 and the communication system 102 may be handled by a communication application (e.g., 120) installed on the user devices 206, 208 or via a web browser (e.g., a web browser application 122) on the user devices 206, 208. Rendering of the session GUIs (e.g., the host GUI 210 of FIG. 2) may also be handled by a communication application 120 and/or via a web browser 122.

FIG. 2 illustrates example data transfers between the user devices 206, 208, the communication system 102, and the protection system 106. Data sent between user devices 206, 208, the communication system 102, and the protection system 106 may include, but is not limited to, audio data, video data, image data (e.g., a shared screen), text data (e.g., typed text/emojis), and other session data. Other session data may include event data indicating user actions during the communication session, such as muting/unmuting a microphone, turning on/off a camera, and entering/leaving a session. A video stream for a user in a communication session may include both video data and audio data for the user. For example, each user device in a video meeting may transmit a video stream that includes video data and audio data, depending on whether the user has turned on/off their camera and whether the user has muted/unmuted their microphone. An audio stream for a user may refer to a stream of just audio data for a user, such as an audio stream during a videoconference or an audio stream in a communication session that includes only audio (e.g., a phone call).

Each user device 206, 208 provides and receives data during the communication session. For example, each user device 206, 208 may provide and receive video data, audio data, text data, and event data. The user devices 206, 208 (e.g., communication applications) may render communication session GUIs (e.g., videoconference GUIs) based on the received data. For example, the host device 206 may render the communication session GUI 210 illustrated in FIG. 2 based on data acquired from the host device 206 as well as data received from the communication system 102. In FIG. 2, the host GUI window 212 includes a video of the host 200, as acquired by a camera on the host device 206. The host device 206 may provide its acquired video, audio, and event data to the communication system 102 so that the User 2 device 208 can include it in the User 2 device GUI (not illustrated). The communication session GUI also includes a participant window 214 for User 2 202 that is showing a video of User 2 202, as acquired by the User 2 device 208 and sent to the host device 206 via the communication system 102. Note that User 2 202 has caused their background to be blurred. The communication session GUI 210 may also include a session text/events window 216 in which text and events for the participants are displayed.

In some implementations, the participant windows may vary in size and location, depending on a number of participants, whether a participant is talking or presenting, and whether participants are sharing materials (e.g., a presentation). In some implementations, the communication session GUI 210 may include another window (e.g., a sharing GUI window) for shared material, such as a shared screen or shared presentation. The communication session GUI 210 illustrated in FIG. 2 is a simplified communication session GUI that has been simplified to illustrate example features of a communication session GUI. As such, it is contemplated that other communication session GUIs may include additional/alternative GUI elements not illustrated in FIG. 2.

The communication session GUI 210 includes a participant window 218 for the protection system 106 that is showing an image indicating that the protection system is (Active). In the case the protection system 106 is stopped (e.g., by selecting/pressing the “Stop” GUI element 204), the protection system GUI window 218 may indicate that the protection system is (Inactive). Although a relatively static protection system GUI window is illustrated (e.g., Active/Inactive), other protection system GUI windows may be rendered based on video and/or audio data provided by the protection system 106.

In some implementations, the host device 206 may include additional controls and monitoring windows relative to other participants. For example, a host may include a protection session interface GUI 220. The protection session interface GUI 220 may include GUI elements that allow the host to control the protection system 106, such as starting or stopping the protection system functionality (e.g., using a Start/Stop GUI element 204). In some implementations, the protection session interface 220 may also receive messages from the protection system 106 described herein (e.g., notifications of detection events).

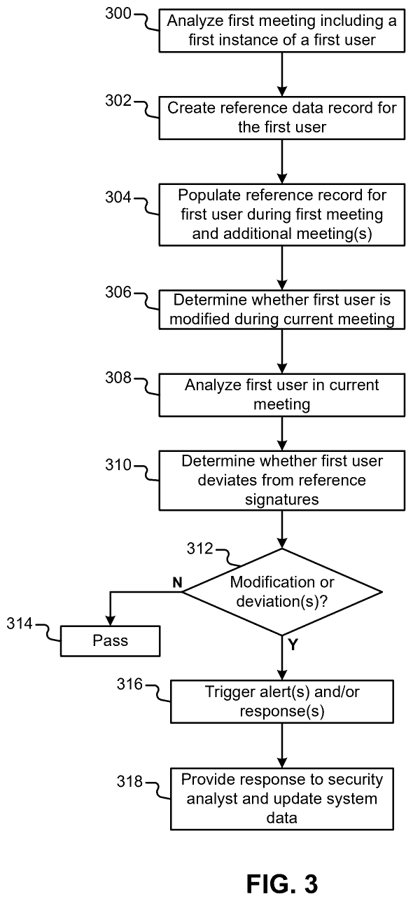

FIG. 3 illustrates a method that describes operation of the environment of FIG. 1A. In FIG. 3, in block 300, the protection system 106 acquires data and analyzes a video meeting including a first instance of a first user. In FIG. 3, it can be assumed that the first meeting is the first instance in which the protection system 106 has analyzed the first user. For example, it can be assumed that the protection system 106 has not collected data for the first user and has not previously generated reference signatures for the first user. As such, the data acquisition system 108 creates a new reference data record (“reference record”) for the first user in block 302. The reference data record may be populated with reference signatures and other data for the user over one or more subsequent meetings.

In block 304, the data acquisition system 108 populates the reference record for the first user during the first meeting and during one or more additional meetings. For example, during the first meeting, the reference record may be populated with a face biometric signature and a voice biometric signature. The reference record may be updated with additional reference signatures over time, such as new biometric signatures, behavioral signatures, language pattern signatures, and environmental signatures. Although the detection system 110 may measure some signatures for a user in a single meeting (e.g., a face biometric signature and a voice biometric signature), some characteristics may require additional meetings for complete measurement. After the first user's reference record has been generated from the completed first meeting in block 300 and other completed additional meeting(s) in block 304, the detection system 110 may have a more complete reference record for analysis of the first user in future meetings.

In block 306, the first user is a participant in a new meeting with additional other users. In the current meeting, the detection system 110 may determine whether the first user is modified in the video stream (e.g., modified using a face swap modification). In block 308, the detection system 110 analyzes the first user in the current meeting. For example, the detection system 110 may extract signatures from the first user video stream in the current meeting.

In block 310, the protection system 106 (e.g., detection system 110 and response system 112) determines whether the first user's signatures in the current meeting deviate from the reference signatures acquired for the first user in previous meetings. If the protection system 106 determines that there are no modifications or deviations in block 312, the response system 112 may determine that the user has passed the checks in block 314 (e.g., the user is who they say they are). If the protection system 106 determines that the first user has been modified and/or the first user's current signatures deviate from the first user's reference signatures in block 312, the response system 112 can trigger one or more alerts and/or trigger one or more responses in block 316. Example alerts described herein may have alert levels (e.g., low, medium, high, critical), alert categories, and alert descriptions.

In block 318, the response system 112 may respond in a variety of ways described herein. For example, the response system 112 may notify the security analyst of the detection events and log the data in the data acquisition system 108. Responses may vary, depending on the alert severity. In some implementations, the response system 112 may include an alert and response table that defines alerts and responses according to detection events and the context of the communication session. In some implementations, the security analyst, or other individual(s) in the organization, may define the alerts and responses in the table according to which events are detected.

FIG. 4A illustrates an example data acquisition system 108 and example data that may be acquired and stored by the data acquisition system 108. The data acquisition system 108 includes an interaction interface module (“interaction module 400”) that acquires communication session data from the users, such as video stream data, audio stream data, event data, and other data described herein. In some implementations, the interaction module 400 may act as a participant (e.g., see identity protection system window 218 of FIG. 2). In these implementations, the interaction module 400 may acquire video data, audio data, and other data in a manner that is similar to a user device (e.g., 100, 206, 208, 402). In some cases, the interaction module 400 may be referred to as an “interaction bot” or a “meeting bot.” Although FIG. 4A illustrates the acquisition of data for a single communication session, the data acquisition system 108 may acquire data from multiple communication sessions simultaneously using multiple instances of the interaction module 400.

In FIG. 4A, the interaction module 400 interacts with a communication session that includes N participants using N user devices 402. As such, the interaction module 400 may receive video data, audio data, and other data for the N participants. The interaction module 400 may also provide video and/or audio data to the communication system 102 for transmission to the N participants. As described herein, in some cases, the interaction module 400 may interact with participants in other manners during a meeting. For example, the interaction module 400 may send messages to the other participants, remove a participant associated with detection events, stop the meeting, and/or perform another action.

The interaction module 400 may store communication session data (“session data” or “meeting data”) in the communication session data store 404 for processing. Example session data may include video streams for each user. For example, video streams may be stored as a continuous stream or as short video files (e.g., a matter of seconds) as the video stream is acquired. Session data may also include audio streams for each user. For example, audio streams may be stored as a continuous stream or as short audio files (e.g., a matter of seconds) as the audio stream is acquired. The session data may also include text data, event data (e.g., mute/unmute, camera on/off, etc.), and other data for each user, as described herein.

FIG. 4B illustrates example data stored for a first session “Session 1 Data 406,” such as a first video meeting. The session data is stored for each of the N users in the session. For example, the communication session data store may store video data, audio data, and other data for each user in the session. The data stored for each user is illustrated as User 1 Session Data 406-1, User 2 Session Data 406-2, . . . and User N Session Data 406-N. In FIG. 4B, the video data, audio data, and other data are illustrated for User 1 Session Data 406-1. The communication session data store 404 may store data for a plurality of meetings at the same time and across a plurality of organizations. The communication system 102 may continuously send the video, audio, and other data to the interaction module 400 for storage in the communication session data store 404.

The User 1 Session Data 406-1 includes a user identifier (ID) 408 and a session identifier (ID) 410 that may uniquely identify the user and the session, respectively. The user ID 408 may include, or be based on, an email address, phone number, or other identifier. The user ID 408 and session ID 410 may be used to associate session data and other data with the user in the protection system 106, such as instance record data (e.g., see FIG. 4C) and reference record signatures/data (e.g., see FIG. 4D).

Example other User 1 Session Data that can be acquired (e.g., other than audio/video data) may include, but is not limited to: 1) session event data, 2) session text data communicated and received by each user, 3) whether each participant is internal/external (e.g., an email within their organization or outside of their organization), 4) a user's company department, 5) a list of participants, when they joined, when they left, when they muted/unmuted their microphones, when they shared their screen/materials, started/stopped their cameras, 6) users'IP addresses, 7) users'locations (e.g., physical geolocation separate from IP addresses, location name, etc.), 8) user device information (e.g., device type, operating system, device identifier, etc.), 9) camera capabilities, and 10) whether the user is modifying their video using virtual camera capabilities (e.g., typical modifications, such as blurred background or synthetic background). The amount of available other session data may depend on the communication system platform being used for the session.

The interaction module 400 may store data in the communication session data store 404 while the interaction module 400 is active, such as after the interaction module 400 is started by a user or automatically started at the beginning of the communication session. The interaction module 400 may refrain from storing data in the communication session data store 404 after the interaction module 400 is stopped manually by the user or automatically at the end of the communication session. The communication session data store 404 may store data until processing for the session is complete, such as when the detection system 110 and response system 112 have finished processing the data included in the communication session data store 404. In some implementations, the communication session data store 404 may store data associated with a detection event for a longer period of time. For example, if an alert is triggered by the response system 112 in a communication session (e.g., an imposter is detected), the communication session data store 404 may store data for the communication session for a longer period of time (e.g., until an analyst reviews the data, confirms review, and deletes the data).

In some implementations, the interaction module 400 may be started manually during a communication session. For example, the host may interact with a GUI element that starts the interaction module 400. In some implementations, the interaction module 400 may automatically start at the start of the communication session. For example, the interaction module 400 may monitor a meeting calendar to determine when a meeting starts. In one example, the communication system 102 that hosts the meeting may notify the interaction module 400 of a scheduled meeting and/or notify the interaction module 400 when the meeting starts. As another example, the interaction module 400 may query the communication system 102 that hosts the meeting to determine when meetings are scheduled and/or have started. Once the interaction module 400 is connected to the meeting, the communication system 102 may continue sending meeting data to the interaction module 400, as described herein.

In some implementations, the host may manually stop the interaction module 400 using a GUI element in the protection session interface 220 (e.g., using a Stop GUI element 204). In some implementations, the interaction module 400 may automatically stop at the end of the communication session. In some implementations, the interaction module 400 may be configured to stop after the protection system 106 has determined that none of the participants are modified and all of the participants have signatures that are consistent with their reference signatures.

In some implementations, the interaction module 400 may be implemented using a software development kit (SDK) and/or an application programming interface (API) provided by the party that operates the communication system 102. In implementations where a communication session is accessed using a web browser, the interaction module 400 may launch a web browser instance to connect to the communication session. Different communication sessions may use different video and audio formats. Example video and audio formats may include, but are not limited to, a Matroska . mkv format, a raw audio format, or other format.

The detection system 110 may analyze the meeting data stored in the communication session data store 404. For example, the detection system 110 may analyze the video and/or audio for each user to extract signatures associated with each user, such as biometric signatures, a behavioral signature, a language pattern signature, and user environmental signatures. In some implementations, storing session data in the session data store 404 may trigger analysis by the detection system 110.

An instance record generation module 412 may store the user signatures extracted by the detection system 110 as well as other session data in instance records 414 for each user during a communication session. For example, the instance record data store 416 may store an instance record 414 for each user in each communication session. In FIG. 4A, N instance records 414 during communication session 1 are illustrated for the N users. For example, for the current communication session, the instance record data store 416 stores Instance Record 1 414-1 for User 1, Instance Record 2 414-2 for User 2, . . . , and Instance Record N 414-N for User N.

Instance records 414 may include any data associated with a single instance of a user in a single communication session. The instance record data store 416 may store data for multiple instances of a user over the course of multiple meetings in multiple different instance records. Storing per-user data on a per-session basis over time may allow for later analysis by the analyst in the case that an instance of the user is associated with one or more detection events (e.g., the user is identified as an imposter). For example, storing per-user data on a per-session basis allows the protection system 106 (e.g., the response system 112) to automatically prepare reports indicating the other meetings that included the suspicious user, other users that interacted with the suspicious user, and any other data associated with the suspicious user. The response system 112 may also generate GUIs for the analyst to use in analyzing the suspicious user, such as dashboards, visual graph data structures showing relations to the suspicious user, or other GUIs.

FIG. 4C illustrates example instance record contents for a single instance of a user in a single communication session (e.g., in a single video meeting). The instance record 418 may include a unique instance record identifier (ID) that may be used to uniquely identify the instance record 418 among all the different instance records stored in the instance record data store 416. The unique identifier may identify that specific instance of a user in a specific session. The instance record 418 may also include one or more user IDs that indicate the user associated with the instance record 418. Example user IDs may include, or be based on, one or more email addresses associated with the user during the session, one or more phone numbers associated with the user, or other data that can be used to identify the user, such as a screen name or other name. The instance record 418 may include a session ID that identifies the specific session in which the user was participating. The instance record 418 may also include any other session data or other data derived from the session (e.g., signatures). The instance record 418 in FIG. 4C includes an IP address for the user, device data for the user, and a user role (e.g., session participant, but not a host). The data illustrated in the instance record 418 of FIG. 4C is only example data that may be stored in an instance record. As such, instance records having additional/alternative data may be implemented in the protection system 106.

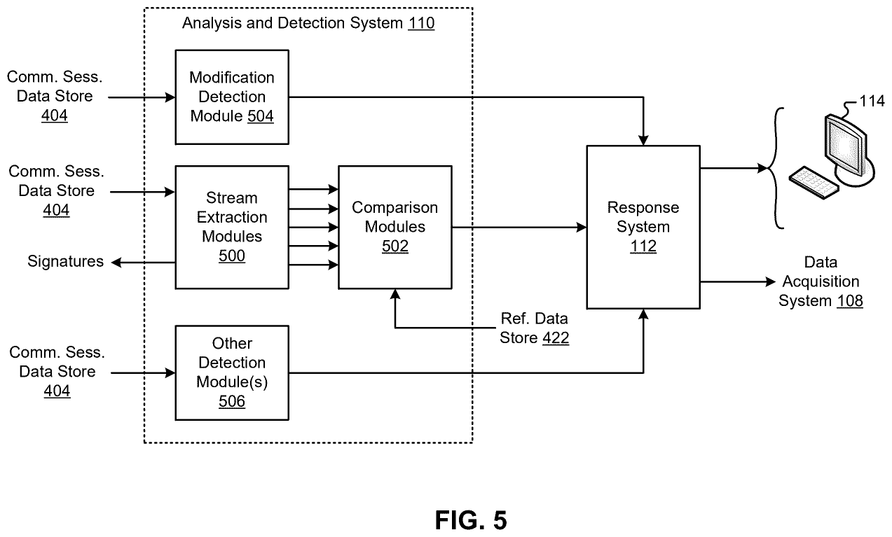

Referring back to FIG. 4A, the data acquisition system 108 includes a reference record generation module 420 (“reference generation module 420”) that generates a reference record for a user based on one or more observed instances of the user in one or more interactions (e.g., a current interaction and one or more prior interactions). For example, the reference generation module 420 may generate and manage a single reference record for each unique user the protection system 106 observes. The single reference record may be updated over the course of one or more meetings. The detection system 110 (e.g., the comparison modules 502 of FIG. 5) may compare a new current instance of a user in a current meeting to their stored reference signatures produced from prior meetings in order to determine whether the current instance of the user deviates from their reference signatures. Deviations between current user signatures and reference signatures may indicate that the current instance of the user may be a different person than has appeared in prior meetings.

The reference generation module 420 may create and update the reference record for a user based on data received from the detection system 110 (e.g., see FIG. 5). For example, the reference generation module 420 may create a reference record for a user in response to a determination that the user is a new user. In one example, the reference generation module 420 may create a reference record the first time a new user is detected in an interaction (e.g., a first time the user ID is used in a meeting). Put another way, the reference generation module 420 may create a reference record when the first instance of a user is detected in an interaction. The data acquisition system 108 includes a reference record data store 422 that may store the reference records 424 for a plurality of users.

The user reference signatures may be absent or incomplete upon creation of the reference record for the user. Upon creation of the reference record, the reference generation module 420 may begin populating the reference record with one or more reference signatures during the first user interaction. The time and/or number of communication sessions for completing different reference signatures may vary based on available data. The reference record may be used in subsequent communication sessions for the user after having one or more completed reference signatures.

The reference signatures may include, but are not limited to, a face biometric signature, a voice biometric signature, a behavioral mannerism signature, a language pattern signature, and/or an environmental signature. Generating reference signatures may require one or more meetings including video and/or audio of the user performing sufficient actions. For example, extracting a face biometric reference signature may require video including the user's face. As another example, extracting a voice biometric reference signature may require audio including the user's voice. Extracting a behavioral mannerism reference signature may require both video and audio for the user. Extracting visual and audio environmental reference signatures may require video and audio, respectively. Extracting a language pattern reference signature may require either audio or an audio transcript of the interaction. Acquiring different reference signatures may also require different amounts of time and/or numbers of communication sessions. For example, acquiring a behavioral mannerism reference signature and a language pattern reference signature may require more time than acquiring a face biometric reference signature or a voice biometric reference signature (e.g., assuming the user speaks). As another example, since a user can change their environment in different meetings, extracting an environmental reference signature may require multiple meetings to sample different environmental locations and/or different camera orientations within the same location.

FIG. 4D illustrates an example reference record 426 that includes reference signatures and other data. The reference records 424, 426 may be indexed by user ID so that the reference signatures can be retrieved by user ID for future instances of the user. In some implementations, the reference generation module 420 may store, in the reference record 424, 426, historic data that was used to generate the reference record (e.g., session IDs, instance record ID(s), etc.) so that an analyst may determine how the reference record was generated in case the user is later associated with an alert.

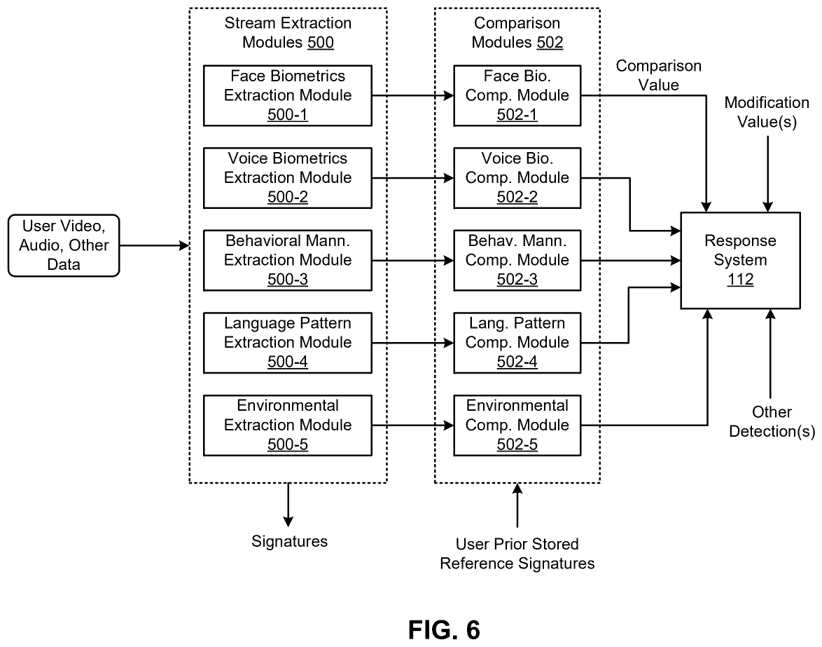

Referring to FIGS. 5-6, the detection system 110 includes stream extraction modules 500 that extract signatures that can be used as reference signatures for the users. Additionally, the detection system 110 may include comparison modules 502 that compare current signatures for a current instance of a user, as determined by the stream extraction modules 500, to stored reference signatures for the user in order to determine whether the user deviates from the reference signatures. The response system 112 may trigger one or more alerts and responses in the case that a user deviates from their reference signatures.

FIG. 6 illustrates example stream extraction modules 500 that extract user signatures from the acquired data (e.g., video/audio data). The example stream extraction modules 500 include a face biometrics extraction module 500-1 (“face biometrics module 500-1”), a voice biometrics extraction module 500-2 (“voice biometrics module 500-2”), a behavioral mannerisms extraction module 500-3 (“behavioral module 500-3”), a language pattern extraction module 500-4 (“language module 500-4”), and an environmental extraction module 500-5 (“environmental module 500-5”).

Biometric data may refer to physical and physiological traits that may be inherent to the user and may be generally unique to the user. Biometric data may be relatively consistent over time. The face biometrics module 500-1 and the voice biometrics module 500-2 may measure a variety of types of biometric data including, but not limited to, face biometric data and voice biometric data. In some implementations, the protection system 106 may measure other biometric data in addition to face biometrics and voice biometrics. For example, the protection system 106 may measure biometric data associated with a user's body and/or hands.

The face biometrics module 500-1 may measure face biometric data for a user that represents a user's face. For example, face biometric data may include data that captures a user's distinctive measurable features (e.g., spatial relationships). In some implementations, the face biometrics module 500-1 may extract a user's face from acquired video frames and use one or more machine learned models (e.g., convolutional neural networks) to extract the face biometric data. In some cases, the face biometric data can be referred to as a face signature. In some implementations, the face signature may be stored as a numeric embedding.

The voice biometrics module 500-2 may measure voice biometric data for a user that represents a user's voice. For example, voice biometric data may include data that captures a user's distinctive combination of pitch, tone, modulation, speech rate, volume, accent, cadence, pauses, and/or other vocal features. In some implementations, the voice biometrics module 500-2 may use one or more machine learned models to extract the voice biometric data from portions of audio including a user's voice. In some cases, the voice biometric data can be referred to as a voice signature.

The behavioral module 500-3 may measure behavioral characteristics for a user that represent patterns of user behavior or user actions that can be used to identify the user. For example, behavioral characteristics may include characteristic patterns of movement, gesture, expression, or interaction observed over time. In one example, behavioral data may indicate user facial expressions and body movements. In another example, a facial expression may include the way a user moves one or more parts of their face (e.g., raises eyebrows while smiling). In another example, behavioral data may indicate how a user moves their arms and hands. In another example, behavioral data may indicate how a user's body moves (e.g., swaying back and forth). The behavioral module 500-3 may extract behavioral data from both audio data and video data. For example, behavioral data may capture how the user moves relative to their voice (e.g., lip movement during speech). In this example, the behavioral module 500-3 may analyze landmarks from the individual's lips as well as the corresponding audio. In some implementations, if the behavioral data is associated with facial features, the behavioral module 500-3 may perform a face extraction step before extracting the behavioral signature using a machine learned model.

In some implementations, the language module 500-4 may measure language patterns that can be used to identify the user, such as characteristic lexical, syntactic, and/or semantic features of their speech. Example language pattern data may include, but is not limited to, frequency of specific words, common phrases, and disfluencies (uh, umm). The language module 500-4 may extract a language pattern signature based on transcripts generated from the audio data.

The environmental module 500-5 may measure visual and/or acoustic environmental characteristics associated with the user over the course of one or more meetings. Example environmental characteristics may include environment venue/location, colors, lighting, and/or other background information about the visual scene. The environmental module 500-5 may identify multiple different user locations over time as well as different views of the same location. In some implementations, the environmental module 500-5 may measure acoustic environmental characteristics for the user, such as acoustic signals caused by the reflections of audio with the user's walls. The environmental module 500-5 may also store acoustic environmental characteristics for the different locations associated with the user. The environmental module 500-5 may take into account the entire video frame when measuring environmental characteristics and extracting an environmental signature.

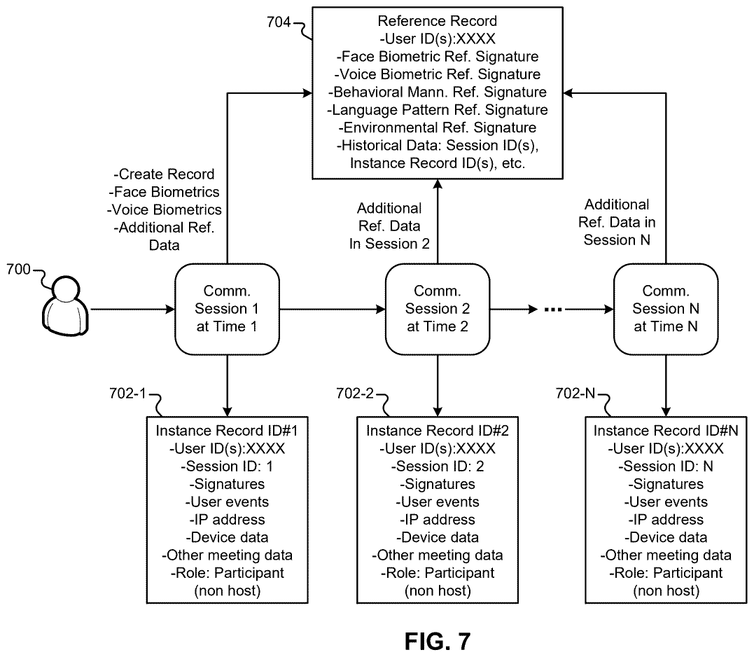

FIG. 7 illustrates example data generated for a user 700 over a plurality of communication sessions. The user 700 in FIG. 7 participates in N sequential communication sessions (e.g., Session 1 at Time 1, Session 2 at Time 2, . . . , and Session N at Time N). The instance record generation module 412 may generate an instance record for the user for each session. Accordingly, in FIG. 7, the instance record generation module 412 generates N sequential instance records (instance records 702-1, 702-2, . . . , 702-N). The reference generation module 420 creates and updates a single reference record 704 using signatures extracted for the user across the N sessions.

As described herein, different types of reference signatures may require different amounts of time, content, and number of sessions to complete. In general, face biometric reference signatures and voice biometric reference signatures may be completed relatively quickly. For example, face biometric reference signatures and voice biometric reference signatures may generally be extracted in a single meeting, assuming that the user is talking and their camera is turned on. Behavioral reference signatures and language pattern reference signatures may take longer to acquire than face/voice signatures. For example, behavioral reference signatures and language reference signatures may require multiple meetings for acquisition. The number of meetings for acquiring environmental signatures may vary, depending on the number of different user locations and user camera orientations.

In FIG. 7, it may be assumed that Session 1 is the first instance of the user interacting with the protection system 106. As such, the reference generation module 420 may create a reference record 704 for the user in Session 1. The reference generation module 420 may also begin populating the reference record 704 with reference signatures. For example, in FIG. 7, the stream extraction modules 500 extract face biometric reference signatures and voice biometric reference signatures that are included in the reference record 704. Additional reference signatures may also be measured during the first session, but, as described herein, extracting a behavioral reference signature, a language pattern reference signature, and an environmental reference signature may require additional meetings. FIG. 7 illustrates the extraction of additional signatures over the course of sessions 2-N that can be used to complete all of the reference signatures for the user.

For each session in FIG. 7, the modification detection module 504 may determine that there are no modifications in the video streams and audio streams. Additionally, for each session, the comparison modules 502 may determine that the current instance of the user matches their prior completed reference signatures. Ensuring that modifications or other user deviations are absent in the session may help ensure the quality and accuracy of the newly acquired reference signatures to be used in the completed reference record 704.

The reference signatures in the reference records may be configured to be resilient to natural variations that will be encountered. Although the signatures may be resilient, the protection system 106 may be configured to update the reference signatures over time. For example, the protection system 106 may add to the reference signatures in order to make a more complete model of the user as the user or their environment changes. As another example, the protection system 106 may update the reference signatures over time to make a more accurate model of the user. With respect to face biometrics, the reference generation module 420 may update the face biometrics reference signature over time to become richer due to different measured head poses, different lighting, levels of facial hair, glasses on/off, or other scenarios (e.g., other facial biometric drift). Similarly, an environmental signature may become richer after measuring environmental background data for multiple backgrounds and different views within the same location. As another example, the protection system 106 may also update the voice biometric reference signature over time to compensate for changes that may occur in the user's voice over time. The response system 112 (e.g., the alert and response table 802) may also be configured in a manner that takes into account the resiliency of different measurements and the accuracy of various detections. In some cases, updating reference signatures may include deletion and replacement of prior reference signatures.

The protection system 106 may update reference signatures using any of the techniques described herein. For example, the protection system 106 may update reference signatures using a passive updating process (e.g., using data acquired from meetings) and/or a more distinct and separate process dedicated to acquiring user signatures (e.g., see FIG. 10). In some implementations, if the user and their environment are determined to be unmodified, the protection system 106 may be configured to update their reference signatures. Building reference signatures over time from video data and audio data that is determined to be unmodified may result in more trustworthy reference signatures. In some implementations, the reference signature updates may be triggered by a passage of time or measured deltas (e.g., biometric drift) relative to past data.

FIGS. 5-6 illustrate features of the detection system 110 that may operate during a session. The detection system 110 includes a modification detection module 504 that may determine whether the user and/or their environment is modified during the meeting. The modification detection module 504 may be configured to detect local modifications (e.g., face modifications or environmental modifications). The modification detection module 504 may also be configured to detect whether the video stream itself is completely synthetically generated.

In some implementations, the modification detection module 504 may include one or more machine learned models that were trained to identify modifications to videos. For example, the modification detection module 504 may be trained to detect local modifications to a user's face (e.g., face swap modifications), head, and/or body (e.g., a completely synthetic user, such as an avatar or agentic deepfake). As another example, the modification detection module 504 may be trained to detect environmental modifications (e.g., background modifications). The one or more machine learned models may have been trained using unmodified videos and modified videos as training data. In a specific example, for a face modification detection model, the model may be trained using video frames with users that have unmodified faces as well as video frames with users that have modified faces (e.g., realistic face swaps). The modification detection module 504 may include additional/alternative models for detecting modifications other than face modifications. For example, the modification detection module 504 may include a trained model that is configured to detect background modifications.

The modification detection module 504 may receive video frames as input. For some models, the modification detection module 504 may extract portions of the video frame for input into the models. For example, the face modification detection model may receive, as input, a portion of a video frame that includes the face (e.g., eyebrows to chin, cheek to cheek). The trained models may receive video frames at a specified rate (e.g., 1 or 2 frames per second). The trained models may output modification values for each frame. The output modification values may indicate whether the frame includes modifications. For example, the face modification model may output a value that indicates the likelihood of the frame including a face modification. In some implementations, the modification detection module 504 may implement thresholds for single model output values and/or aggregate values. For example, the modification detection module 504 may include a threshold value, above which a model output indicates that a modification is present in the video stream. In some implementations, the modification detection module 504 may evaluate (e.g., integrate) a plurality of individual modification values over a plurality of frames to determine final modification values for the different modifications being evaluated. The output modification values may be output in a variety of different formats, depending on the implementation. For example, the output modification values may be formatted as decimal numbers, binary (0/1), or as another format.

After evaluation of a plurality of video frames (e.g., using one or more models, integrations, and/or threshold values), the modification detection module 504 may output final modification values that indicate to the response system 112 whether the user and/or environment has been modified. For example, the modification detection module 504 may output a face modification value that indicates whether a user's face has been modified. As another example, the modification detection module 504 may output an environmental modification value that indicates whether the environment has been modified. As another example, the modification detection module 504 may output a modification value that indicates whether the entire video/frame is synthetic.

In some implementations, the modification detection module 504 may be configured to detect audio modifications, such as voice modifications. In these implementations, the modification detection module 504 may receive audio as input. For example, the modification detection module 504 may receive multiple multi-second portions of audio (e.g., 4 second portions of audio) for analysis. The modification detection module 504 may assess whether the audio has been modified after analysis of a plurality of the received audio portions. In some implementations, the modification detection module 504 may include an audio modification detection model (e.g., a trained model) that may identify whether the audio includes a modified voice. For example, the model may determine whether patterns exist in the voice that are distinctive of a fake/modified voice. The modification detection module 504 may output a final audio modification value that indicates whether the audio (e.g., a user's voice) in the session has been modified. The output audio modification values may be output in a variety of different formats, depending on the implementation. For example, the values may be formatted as decimal numbers, binary (0/1), or as another format.

The detection system 110 includes other detection modules 506 that may also operate at the start of the meeting, during the meeting, or after the meeting has concluded, depending on when data is available for the other detection modules 506. In one example, the other detection modules 506 may include a known bad actor detection module that determines whether the user is a known bad actor based on a comparison of the user's face biometric signature to a data store (not illustrated) of known bad actor biometric signatures. The data store, which may be stored at the protection system 106, may be compiled from photographs and other biometric data of known criminals, state actors, or other users that may be desirable to detect in meetings. In some cases, the known bad actors may have been users that were detected by the protection system 106 in the past (e.g., past imposters).

The other detection modules 506 may also detect other events that may be relevant to the analyst. For example, other detection modules 506 may detect suspicious IP addresses, suspicious email addresses, inconsistencies in IP address and reported location (e.g., a manually reported location, geolocation, IP address based location, etc.), computer/camera inconsistencies, or other data that may indicate the user is a bad actor. In some implementations, environmental reference signatures for a user may be associated with a location, such as a manually reported location (e.g., a city/state, building, and/or meeting room reported by a user), a geolocation indicated by the user's device, a location associated with an IP address, or another location. In these implementations, the other detection modules 506 may detect inconsistencies between the environmental reference signatures and the user location. For example, if the environmental reference signature matches for a first location, but the user is in a second location (different than the first location), the other detection modules 506 may trigger a detection event. In a specific example, if a current environmental signature associated with a user's office located in a known geolocation is matched with its environmental reference signature, but the user is at a determined location that is other than the office, the other detection modules 506 may trigger a detection event.

FIG. 6 illustrates example stream extraction modules 500 that extract signatures for a current instance of the user. The current instance signatures are then compared to reference signatures by corresponding comparison modules 502. Each comparison module may output respective comparison values that indicate whether the current instance of the user deviates from, or matches, the reference signatures. In some implementations, the stream extraction modules 500 and the comparison modules 502 may wait until after the user has been determined to be real (unmodified) before determining whether the user signature for the current instance of the user matches the stored reference signatures.

During the session, the stream extraction modules 500 may extract the signatures described herein. For example, the face biometrics module 500-1 may extract a face biometric signature. The voice biometrics module 500-2 may extract a voice biometric signature. The behavioral module 500-3 may extract a behavioral mannerism signature. The language module 500-4 may extract a language pattern signature. The environmental module 500-5 may extract an environmental signature.

As described herein, extraction of the various signatures may require a variety of different types of data, such as video data and/or audio data. The different types of data may require different user actions during the meeting (e.g., a user may be required to speak for acquisition of voice biometrics). The face biometrics module 500-1 may use individual video frames with face extraction. The voice biometrics module 500-2 may use portions of audio (e.g., multi-second portions of audio) in which the user is speaking. The behavioral module 500-3 may use both video and audio with face localization (e.g., if the behavior being measured occurs in a user's face). The language module 500-4 may use audio transcripts and also require the user to talk. The environmental module 500-5 may measure the entire video frame and may include a static background in many cases.

In general, the face biometric signature and the environmental signature may be acquired first in a session, assuming the user has their camera on. The voice biometric signature may also be acquired in a relative short period of time, assuming the user speaks. For example, face and voice biometric signatures may be acquired within a minute or a few minutes of video, depending on user behavior. The behavioral signature and language pattern signature may require more time, as data measurement may require more user actions.

The comparison modules 502 output comparison values based on the comparisons between the current signatures and the corresponding reference signatures. For example, a face biometrics comparison module 502-1 and a voice biometrics comparison module 502-2 may output face and voice biometrics comparison values, respectively. The behavioral mannerisms comparison module 502-3 may output a behavioral comparison value. The language pattern comparison module 502-4 may output a language pattern comparison value. The environmental comparison module 502-5 may output an environmental comparison value.

A comparison value may indicate the probability or level of confidence that the respective signature for the current user deviates from the respective reference signature for the current user. In some implementations, the comparison values may be represented as floating point numbers that may indicate a probability (e.g., a percentage) that the current user matches or deviates from the reference signatures. For example, the face biometric comparison value may indicate a probability or level of confidence that the current user's face matches the reference face signature.

In some implementations, each of the comparison modules 502 may receive multiple sequential signatures and make a comparison for each received signature. In these implementations, each of the comparison modules 502 may determine a final comparison value based on the plurality of comparison values. For example, each of the comparison modules 502 may output a final comparison value when the final comparison value is determined to be accurate and reliable (e.g., stable over a number of observations and/or period of time).

The comparison modules 502 may be implemented in a variety of ways. With respect to comparisons of biometric signatures to reference signatures, a biometric signature may be represented as a vector of numeric values that embody the relevant biometric signal. Two such signatures/vectors can be compared for similarity using several different approaches. In one example, a dot product may be used, where the dot product yields a similarity value bounded between +1 (maximally similar) to −1 (maximally dissimilar). In another example, an L2 norm may be used, where the L2 norm (or Euclidean distance) yields a similarity value in which the closer the value is to 0, the more similar the pair of vectors. In another example, a classifier may be used, such as a linear discriminant analysis (LDA) or support vector machine (SVM) or multi-layer perceptron (MLP) that can be trained to compare a biometric signature to a collection of reference biometric signals.

In some implementations, all comparison values may not be available at the same time. The comparison modules 502, or other modules, may indicate the temporary lack of availability to the response system 112 so that the response system 112 can provide a valid response based on complete information. For example, comparison values may not be available during a session if there is not a reference signature available for comparison (e.g., a reference signature has not yet been completed). In these sessions, the comparison values may indicate to the response system 112 that a valid comparison value will not be ready during the session (e.g., an N/A value). As another example, since different current signature data for the user may depend on user actions (e.g., speaking), different comparisons may be available at different times in the session, or not available at all. As another example, different signatures may require a different amount of time to calculate. In these sessions, a comparison value may indicate that it is not currently available, but will be made available when ready (e.g., an “in-progress” value).

In some implementations, the detection system 110 may perform continuous checks for modifications, deviations from reference signatures, and/or other detections during an entire communication session. In some implementations, the detection system 110 may perform initial checks for modifications, deviations, and/or other detections. In these implementations with initial checks, after initial checks pass (e.g., no detected modifications, deviations, or other detections), the detection system 110 may refrain from performing additional checks during the communication session in order to save computing resources. In some implementations, the detection system 110 may be configured to perform checks according to a schedule that differs from continuous checks or solely initial checks. For example, the detection system 110 may perform some checks throughout the session (e.g., modification checks), while the detection system 110 may perform more limited checks (e.g., periodic checks) for signature deviations or other detections after the user has passed initial checks.

The detection system 110 may output a plurality of values that the response system 112 may use to determine whether to trigger one or more alerts and one or more responses. For example, the detection system 110 may output one or more modification values indicating whether the session includes video and/or audio modifications. As another example, the detection system 110 may output one or more comparison values indicating whether the user differs from their reference signature. As another example, the detection system 110 may output other values that may indicate a detection of a known bad actor, a known bad actor IP address, or other inconsistencies that may be of note to determining whether a user is malicious.

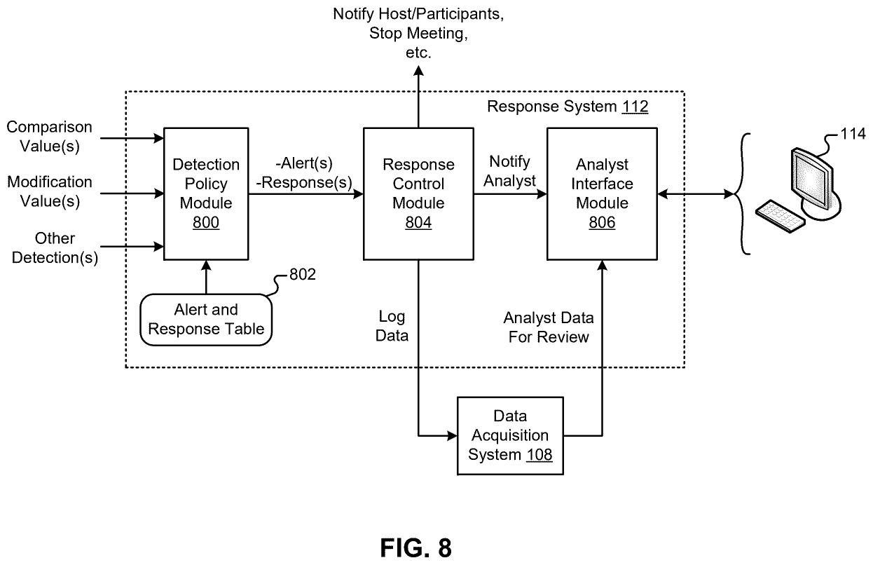

Referring to FIG. 8, the response system 112 includes a detection policy module 800 (“policy module 800”) that receives the values output by the detection system 110. The policy module 800 may determine that an event has been detected based on the value received from the detection system 110. For example, with respect to a face modification value, the policy module 800 may determine that a user's face has been modified when the modification value indicates a high probability that the face has been modified.

In some implementations, the policy module 800 may implement thresholding or another evaluation technique for determining whether the received comparison values indicate a detection event. For example, the policy module 800 may interpret a comparison value as indicating a detection event when the comparison value is greater than a threshold value. In this example, the policy module 800 may interpret a comparison value that is less than a threshold value as not indicating a detection event. The protection system provider and/or the analyst may define thresholds or other evaluation techniques that define detection events for the various comparison values.

The policy module 800 may detect a variety of events. The detection events determined for a user during a session may be referred to as a set of detection events (e.g., a set of one or more detection events). Example detection events may include modification events, such as a face modification event or a background modification event. Another example detection event may include a face biometric event that may be detected when a user's current face biometric signature deviates from their face biometric reference signature. Another example detection event may include a voice biometric event that may be detected when a user's current voice biometric signature deviates from their voice biometric reference signature. Another example detection event may include a behavioral event that may be detected when a user's behavioral signature deviates from their behavioral reference signature. Another example detection event may include a language pattern event that may be detected when a user's current language pattern signature deviates from their language pattern reference signature. Another example detection event may include an environmental event that may be detected when the current environmental signature deviates, or otherwise does not match, their environmental reference signature. The policy module 800 may also detect other events, such as a known bad actor event when there is a biometric signature match with a known bad actor. Another example detection event may include a metadata event that may occur when the user's metadata indicates that the user is a bad actor (e.g., known bad IP address, known bad actor email address, or other detection).

Although the policy module 800 may determine whether a detection event has occurred based on values received from the detection system 110, in some implementations, the detection system modules (e.g., comparison modules 502) may be configured to output binary values (e.g., 0/1) that indicate whether a respective detection event has occurred.

The policy module 800 may trigger one or more alerts and one or more responses based on the set of one or more detection events. In some implementations, the policy module 800 may determine the alerts and/or responses using an alert and response table 802 (hereinafter “response table 802”) that maps the set of detection events to the alerts and responses. Although alerts and responses may be selected from a table data structure, in other implementations, selections of alerts and responses may include other functionality, such as weighted functions or machine learned models that define alerts/responses.

In some implementations, the response table 802 may take into account additional inputs other than detection events. For example, in some implementations, the response table 802 may take into account the context of the interaction. In these implementations, the context of the interaction may define whether an alert/response is triggered and/or the severity of the alert and the response. For example, higher stakes meetings may require fewer detections and/or may result in more strict responses. In one example, if the interaction is a legal deposition, the policy module 800 may trigger a higher alert level and a stronger response than if the interaction is a casual conversation.

In some implementations, context may include meeting type, such as a job interview. A job interview may have a different set of alerts/responses than other typical conversations. For example, the policy module 800 may not allow any types of video modifications in a job interview (e.g., according to corporate policy). In this example, any detection event involving a modification to the user's background (e.g., a blurred background) may trigger a high level alert and may end the meeting. In another example described herein, a court proceeding may have an elevated level of alert and response for detected events.

The policy module 800 may determine context in a variety of ways. In some implementations, there may be a default context set by the party that provides the protection system 106. In some implementations, the analyst (or other person in the organization) may configure the context according to their company's policy. In some implementations, context for an interaction may be set manually, such as by a meeting host (e.g., interviewer, recruiter, etc.). In some implementations, the context for the meeting may be determined automatically. For example, the context may be determined based on access to other computing systems (e.g., a job applicant tracking system), based on the participants in the meeting, words used during the meeting, or for other reasons. In one example, the policy module 800 may determine that a meeting is for a job interview if the interviewer labels the scheduled meeting as a job interview or interacts with the interface during the meeting to label it as a job interview. In another example, the policy module 800 may automatically detect that the participants in the meeting are part of a job interview because the interviewee is included in the company's applicant tracking system for hiring new employees.

An alert may have an associated severity level that is selected from a plurality of severity levels (e.g., two or more severity levels). For example, an alert may be a low, medium, high, or critical severity level. In some implementations, the alert severity level may correspond to the level of response triggered by the policy module 800. For example, an alert with a greater severity level may trigger a more immediate and substantial response. In one example, a critical alert may be configured to end a meeting, immediately notify an analyst, and/or require analyst action. A lower severity alert (e.g., a low or medium alert) may trigger a less immediate and substantial response (e.g., a report may be stored for the alert). The analyst may set the alert severities for different combinations of detections and contexts. For example, the analyst may set the alert severities in an analyst interface (e.g., by selecting the alert severity from menus or interacting with a spreadsheet that defines alerts for inputs).

An alert may have an associated category, subcategory, and/or description. The category, subcategory, and description may describe the detected events. For example, the description may indicate the detection events that caused the alert, such as a list of detection events that occurred and a list of those that did not occur. Descriptions may include textual descriptions of the detection events. For example, if a face modification is detected, the description for the alert may indicate what may cause a face modification detection event, such as a participant using a face swap software to hide their identity for malicious purposes. Categories and subcategories may also describe the set of detection events in a more concise manner than the description. For example, if voice biometrics do not match, the category may include “voice manipulation.” A category and subcategory for a mismatch in voice biometrics may include the category “suspicious identity” and the subcategory “voice manipulation.” As another example, if there is a modified face detection that is human realistic, the category and subcategory for the alert may include “suspicious identity” and “realistic face modification,” respectively. As another example, if there is a modified face detection that is not realistic (e.g., an animal face swap over a human user), the category and subcategory for the alert may include “suspicious identity” and “unrealistic face modification.”

The responses may be defined in the response table 802 by default and/or an analyst may modify the response in the response table 802 using the analyst interface. The response system 112 (e.g., the response control module 804) may provide one or more responses according to the response table. An example response may include logging data associated with the alert and response (e.g., in an alert incident report). For example, the response control module 804 may log the alert level, description, category, and response to be taken. Another example response may include logging data associated with the meeting and participants that triggered the alert (e.g., in an alert incident report). For example, the response control module 804 may annotate the instance records to indicate which meeting included the alert and which participant(s) caused the alert.

Another example response may include notifying one or more participants in the meeting that an alert has been triggered. For example, the response control module 804 may notify the host and/or other participants that did not trigger the alert. In some implementations, the response control module 804 may notify the participants via the interaction module 400 (e.g., via text data sent in the meeting). In other implementations, the response control module 804 may trigger a notification via another communication channel, such as via a text message, email, or other message. A notification to participants may include a description of the alert, category of the alert, or other information needed by the participants to understand the reasoning for the notification.

Another example response may include notifying an analyst that an alert has been triggered. The notification may be sent in real-time while the meeting is occurring or after the meeting has concluded. For example, the notification may be sent to the analyst security application 118, via phone text message, phone call, email, and/or via another other communication channel. In some implementations, the notification may request an analyst response. Example analyst responses may include confirmation of receipt or confirmation that the alert has been investigated and handled by the analyst. In some implementations, the analyst may join the in-progress meeting that triggered the alert. In some implementations, the analyst may review the meeting (e.g., a recording) after the meeting has concluded. Another example response may include automatically removing the user causing the detection events or automatically stopping the meeting (e.g., if the alerts are critical).

In some implementations, the analyst may define a sequence of actions to be performed (e.g., in an analyst interface) in response to an alert. For example, the analyst may configure the response control module 804 to cause removal of a user that triggers a face modification detection event. After removal of the user, the response control module 804 may notify the remaining participants of the removal as a follow up in the meeting (e.g., via the session text/events interface 216 in the video meeting GUI).

An analyst may configure the alerts and responses in any manner. In general, the analyst may configure the alerts and responses to be commensurate with the severity of the detection events and the context of the interaction. The example detection events, contexts, and corresponding alerts/responses described herein are only examples. As such, the response system 112 may be configured to generate alerts and respond in a different manner than is explicitly described herein.

In some implementations, more severe alerts (e.g., high or critical alerts) may correspond to scenarios where detections may be more indicative of malicious intent by one or more participants. For example, detection of a realistic face modification may be labeled as a critical alert in many contexts, as such a modification can be used to hide a user's true identity and/or impersonate another user. As another example, deviation in a user's face biometrics may be labeled as a critical alert in many contexts, as a mismatch in face biometrics may indicate that the user in a current meeting is pretending to be someone else with the intent of deceiving the other meeting participants. As another example, a detection of a known bad actor may be labeled as a critical alert, even in the absence of other detections.

In some implementations, less severe alerts (e.g., a low/medium alert) may include scenarios that do not require immediate analyst attention. Less severe alerts may be associated with detections that are less indicative of malicious intent. For example, less severe alerts may be more indicative of typical user behavior. In one example, detection of a modification to the background of a user (e.g., a blurred background or artificial background) may be a typical action taken by a user during a meeting that is typically not associated with malicious intent. As another example, different real backgrounds, in and of themselves, may be considered a less severe alert because a user may commonly choose different physical locations for taking meetings. Low severity alerts, such as modifications to backgrounds or differing backgrounds, may result in a less substantial response, such as data logging that indicates the detection in the data acquisition system 108 (e.g., in an instance record). Logging data for less severe alerts without immediately notifying an analyst may save the analyst from wasting time investigating more typical detection events while also maintaining a record that the analyst can investigate in the future (e.g., if one of the users is involved in a more critical incident in the future).

In some implementations, the severity level of the alert may correspond to a conclusion that is due to a combination of factors that provide an overall better picture of the interaction. For example, detection of a deviation in voice biometrics may be indicative of an imposter, but the voice biometrics may differ due to sickness or another voice issue. Accordingly, in this case, if the face biometrics do not differ, the severity of the alert may be lowered relative to other possible alerts related to imposters. As another example, if a face modification is not detected and face biometrics do not differ, but the voice, language pattern, and background set off detection events, the severity level may be increased, as the protection system 106 may have missed the face biometrics or the modification. In implementations where the detection system 110 (e.g., comparison modules 500) provide confidence levels associated with detection events, the policy module 800 may lower the alert statuses for lower confidence events.

In some implementations, some detection events may include additional analysis associated with the detections. For example, if the policy module 800 detects a face modification event (e.g., a face swap), the response system 112 (e.g., the response control module 804) may attempt to match the offending user's face with other users having their face biometrics stored in the data acquisition system 108 (e.g., in reference records). In this example, matching a face modification to another user in the reference data store 422 may indicate that the offending user is attempting to impersonate a person at their company or another company. Such a detection may be configured to trigger a critical alert and notify the analyst.

The response system includes an analyst interface module 806 that provides security analysis features to a security analyst via a security analyst device 114. In some implementations, the analyst interface module 806 may provide an interface for the security analyst that allows the analyst to configure any parameters of the protection system 106 described herein. For example, the analyst can define alert levels and one or more responses for corresponding detection events.

The analyst interface module 806 may also provide the analyst with an analyst GUI for investigating detection events. For example, the analyst interface module 806 may provide a security analyst with incident/event reports associated with communication sessions. As another example, the analyst interface module 806 may provide GUIs for performing analysis on data associated with prior/current communication sessions. For example, the analyst interface module 806 may provide graph visualizations of offending users and their other interactions so that the analyst can easily investigate the other interactions and other possible past security issues associated with the offending users.

In some implementations, the analyst interface module 806 may allow the security analyst to intervene during a communication session. For example, in response to detection of an event (e.g., a face modification), the analyst may notify participants in the communication session and/or terminate the communication session. The analyst interface module 806 may also provide a GUI for the analyst to review a recorded communication session associated with one or more detection events.

In some implementations, the analyst interface module 806 may provide the analyst with a GUI to annotate various collected data. For example, an analyst may confirm that detection events have been reviewed. The analyst may also provide text input for detection events that provide the analyst's reasoning associated with handling the events.

As described herein, different detections may require different amounts of time to calculate during a communication session (e.g., depending on available audio/video data). As such, in some implementations, the detection events provided to the policy module 800 may be provided at different times. In these implementations, the policy module 800 may trigger one or more additional alerts and one or more additional responses based on one or more newly received detection events. In a specific example, the policy module 800 may increase the level of alert(s) and trigger a more substantial response, according to the response table 802, in the case where more severe events (e.g., face swaps or unmodified imposters) are detected later in the communication session.

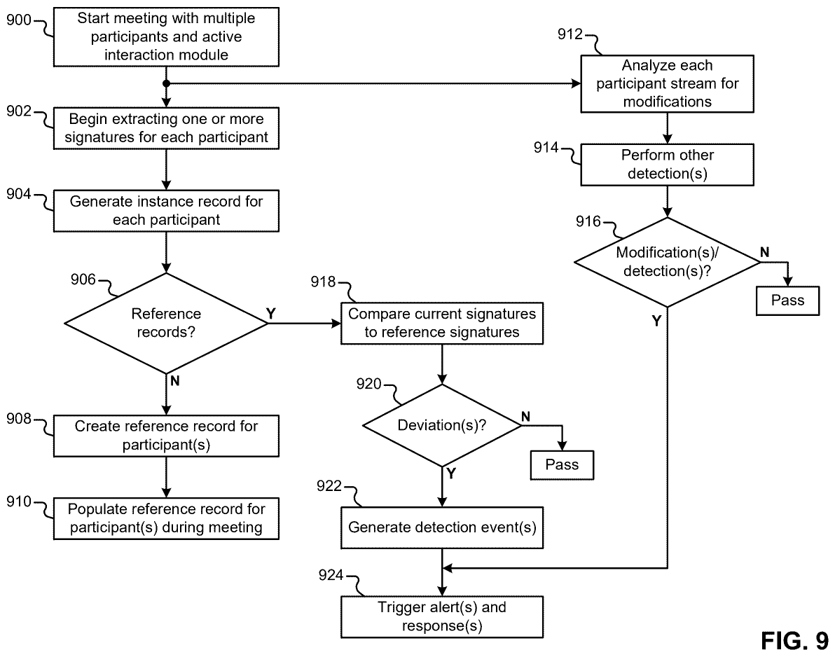

FIG. 9 illustrates example operation of the protection system 106 during a video meeting that includes a plurality of participants. In block 900, a video meeting starts that includes a plurality of participants and an active interaction module 400 that is integrated into the video meeting. In block 902, the stream extraction modules 500 begin extracting one or more signatures for each of the participants. In block 904, the instance record generation module 412 generates instance records for each of the participants.

In block 906, the reference generation module 420 determines whether each participant is associated with a stored reference record (e.g., based on their user IDs). If a participant does not have a stored reference record in block 906, the reference generation module 420 may create a new reference record for the participant in block 908 and populate the reference record with one or more signatures in block 910 during the video meeting.

In block 912, the modification detection module 504 may analyze each video stream to determine whether the video streams include modifications (e.g., face modifications, background modifications, etc.). In block 914, the other detection modules 506 may determine whether any other events are detected, such as detection of a known bad actor. If no modifications or detections are identified in block 916, the current video meeting may pass the respective tests. In some implementations, blocks 912-916 may be performed at the start of the video meeting (e.g., in parallel to blocks 902-910 and blocks 918-924). In other implementations, blocks 912-916 may be performed prior to other blocks in the method in order to initially determine whether the streams include real human participants before generating instance records and extracting/comparing signatures.

In block 918, the comparison modules 502 may compare the current signatures for the participants to their respective reference signatures. In block 920, the policy module 800 may determine whether any of the current signatures deviate from the reference signatures. If there are no deviations in block 920, the video meeting may pass the respective tests (e.g., policy module 800 determines that no events are detected).

If there are deviations in block 920 for one or more participants, the policy module 800 may generate detection events that indicate which signatures have deviated in block 922. In block 924, the policy module 800 may trigger one or more alerts and one or more responses based on the detection events generated in block 922 and blocks 912-916.

FIG. 10 illustrates a separate signature extraction GUI 1000 that may be provided by the protection system 106 in order to acquire signatures for a user outside of a typical communication session. In FIG. 10, the user 1002 has already started face biometric signature extraction by touching/clicking a “Start Face Acquisition” button (e.g., previously rendered in the position of the illustrated Stop Face Acquisition button 1004). In the process, the user 1002 is instructed to move their head to show different angles of their face. The protection system 106 may extract face biometric signatures from the acquired video stream. The user may also select a “Start Voice Acquisition” button 1006 to be presented with a script to read in order to provide audio data for the protection system 106 to generate a voice biometric signature. Although processes for extracting face and voice signatures are described with respect to the signature extraction GUI 1000 of FIG. 10, other signatures may also be extracted in the same manner, such as behavioral signatures, environmental signatures, and/or language pattern signatures.

In some implementations, the signature extraction GUI 1000 and process of FIG. 10 may be used to extract reference signatures for a user outside of a meeting. The process of FIG. 10 is in contrast to the passive extraction of reference signatures that may occur during typical communication sessions. The protection system 106 may provide the signature extraction GUI 1000 and process of FIG. 10 to a user in a variety of scenarios. For example, the signature extraction GUI and process may be used to acquire initial reference signatures for a user at any time prior to a meeting in which the user's signatures will be extracted and compared in order to protect the user's identity (e.g., after the user is hired). As another example, the signature extraction GUI and process may be used to update or complete a reference record for a user that is otherwise incomplete (e.g., due to a lack of video/audio data).

In some implementations, the signature extraction GUI 1000 and process of FIG. 10 may be used to verify the user's identity. For example, the protection system 106 may provide the GUI and process to a user in order to extract current signatures from the user for comparison to prior stored reference signatures. In one example, the protection system 106 may present the GUI and process to a user prior to a meeting or during a meeting in order to verify that the correct user is present in the meeting. As another example, the protection system 106 may present the GUI and process to a user that is associated with one or more detection events in a meeting. For example, if a user is associated with a face biometric event (e.g., their face biometrics deviate from a reference), the user may be automatically presented with the signature extraction GUI and process in order to verify their current face and voice signatures relative to their stored references.

Although the protection system 106 may be configured to detect modifications in video/audio data and/or detect deviations in users over time, in some implementations, the protection system 106 may be configured to authenticate a user by finding one or more reference signatures associated with the user. For example, during a communication session, the protection system 106 may search for a reference record that includes one or more reference signatures that match current signatures for a user. In a specific example, the protection system 106 may determine that a user matches a stored set of reference signatures based on comparison values generated based on the user's current signatures and the stored reference signatures. Identifying a reference record that includes one or more reference signatures that match a user may authenticate the user's identity. The protection system 106 may be configured to match any of the stored reference signatures to a current user. In some implementations, the protection system 106 may initially limit matches to face biometrics and/or voice biometrics or other signatures that may be more unique to the user. Matching a user's current signatures to stored reference signatures may be useful in authenticating the user. Additionally, or alternatively, matching a user's current signatures to stored reference signatures may be useful for users that do not have other user IDs available for identifying an existing reference record. This may be the case if the protection system 106 does not have access to a user's user ID, such as when the protection system 106 does not have access to a user's email address, a user's phone number, or other identifier. This may also be the case when the user is accessing a meeting with another user's device and/or is sitting alongside another user in a meeting while sharing the other user's device.

The methods described herein are only example methods that include example orders of operations. As such, example operations described herein may be added to the methods or removed from the methods. The operations described in the methods may also be rearranged into a different order than explicitly illustrated.

The data structures (e.g., session data, instance records, and reference data records) and data stores described herein are only example data structures and data stores. As such, the devices and systems described herein may implement the techniques of the present disclosure using additional/alternative data structures and data stores. The data structures may be implemented in a variety of different ways, which may include, but are not limited to, one or more databases, files, indices (e.g., inverted indices), tables, or other data structures. The data structures, data stores, and data processing described herein may be implemented in a secure manner that protects user privacy.

Modules and data stores included in the systems represent features that may be included in the systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems may include one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems may be configured to communicate with the network 104 of FIG. 1. The one or more computing devices of the systems may also be configured to communicate with one another (e.g., via a computer network). In some examples, the one or more computing devices of the systems may include one or more server computing devices configured to communicate with user devices. The one or more computing devices may reside within a single machine at a single geographic location in some examples. In other examples, the one or more computing devices may reside within multiple machines at a single geographic location. In still other examples, the one or more computing devices of the systems may be distributed across a number of geographic locations.

What is claimed is:

1. A method comprising:
acquiring, at a server, a first video stream including a first instance of a first user from a first video meeting with a plurality of additional users;
determining, at the server, that the first user in the first instance has not been modified in the first video stream;
creating, at the server, a reference data record for the first user that includes a face biometric reference signature extracted from the first video stream, wherein the face biometric reference signature indicates features of the first user's face;
acquiring, at the server, one or more subsequent video streams from a plurality of subsequent video meetings including subsequent instances of the first user;
updating, at the server, the reference data record to include an additional reference signature for the first user extracted from audio data and video data in the first video stream and one or more of the subsequent video streams;
during a current video stream for a current video meeting including a current instance of the first user:
detecting a face biometric event if a current face biometric signature for the current instance of the first user deviates from the face biometric reference signature; and
detecting an additional event if a current additional signature for the current instance of the first user deviates from the additional reference signature; and
providing, from the server, a first response to a security analyst device based on whether the face biometric event was detected and based on whether the additional event was detected, wherein the first response is selected from a table that maps one or more responses to a set of one or more different events.

2. The method of claim 1, wherein determining that the first user in the first instance has not been modified comprises determining that the first user's face has not been modified, the method further comprising creating the reference data record for the first user that includes the face biometric reference signature in response to determining that the first user's face has not been modified.

3. The method of claim 1, wherein the additional reference signature, the additional event, and the current additional signature are a voice biometric reference signature, a voice biometric event, and a current voice biometric signature, respectively, and wherein the voice biometric reference signature represents the first user's voice.

4. The method of claim 3, further comprising:
determining that the first user's voice has not been modified in the first video stream; and
extracting the voice biometric reference signature from the first video stream in response to determining that the first user's voice has not been modified in the first video stream.

5. The method of claim 1, wherein the additional reference signature, the additional event, and the current additional signature are a behavioral reference signature, a behavioral event, and a current behavioral signature, respectively, and wherein the behavioral reference signature indicates how the first user moves at least one of their face and their body.

6. The method of claim 1, wherein the additional reference signature, the additional event, and the current additional signature are a language pattern reference signature, a language pattern event, and a current language pattern signature, respectively, wherein the method further comprises extracting the language pattern reference signature from audio transcripts of at least one of the first video stream and one or more of the subsequent video streams, and wherein the language pattern reference signature indicates a frequency of specific words used by the first user.

7. The method of claim 1, wherein the additional reference signature, the additional event, and the current additional signature are an environmental reference signature, an environmental event, and a current environmental signature, respectively, and wherein the environmental reference signature represents visual characteristics associated with one or more of the first user's locations.

8. The method of claim 7, further comprising:
determining the first user's current location in the current video stream;
determining that the first user's current location does not match with the first user's current environmental signature; and
providing the first response based on the mismatch between the first user's current location and the first user's current environmental signature.

9. The method of claim 1, further comprising updating the face biometric reference signature and the additional reference signature based on additional video streams that occur after the one or more subsequent video streams.

10. The method of claim 1, further comprising:
determining whether the first user's face in the current instance has been modified in the current video stream; and
providing the first response based on whether the first user's face in the current instance has been modified.

11. The method of claim 1, further comprising:
determining that the first user's face in the current instance has been modified in the current video stream;
determining that the modified first user's face matches a known second user's face associated with a stored face biometric reference signature for the second user; and
providing a second response to the security analyst device indicating that the current instance of the first user in the current video stream is an imposter that has modified their face to match the known second user's face.

12. The method of claim 1, wherein the first response indicates to the security analyst device that the current instance of the first user is an imposter when at least one of the face biometric event and the additional event is detected.

13. The method of claim 1, wherein a second response includes removing the first user from the current video meeting when at least one of the face biometric event and the additional event is detected.

14. The method of claim 1, wherein a second response includes notifying other users in the current video meeting that the first user is an imposter when at least one of the face biometric event and the additional event is detected.

15. The method of claim 1, further comprising modifying the table based on input from the analyst device.

16. A system comprising:
one or more storage devices configured to store a reference data record for a first user;
one or more processing units configured to execute computer-readable instructions that cause the one or more processing units to:
acquire a first video stream including a first instance of the first user from a first video meeting with a plurality of additional users;
determine that the first user in the first instance has not been modified in the first video stream;
extract a face biometric reference signature from the first video stream, wherein the face biometric reference signature indicates features of the first user's face;
store the face biometric reference signature in the reference data record;
acquire one or more subsequent video streams from a plurality of subsequent video meetings including subsequent instances of the first user;
update the reference data record to include an additional reference signature for the first user extracted from audio data and video data in the first video stream and one or more of the subsequent video streams;
during a current video stream for a current video meeting including a current instance of the first user:
detect a face biometric event if a current face biometric signature for the current instance of the first user deviates from the face biometric reference signature; and
detect an additional event if a current additional signature for the current instance of the first user deviates from the additional reference signature; and
provide a first response to a security analyst device based on whether the face biometric event was detected and based on whether the additional event was detected, wherein the first response is selected from a table that maps one or more responses to a set of one or more different events.

17. The system of claim 16, wherein the computer-readable instructions cause the one or more processing units to:
determine that the first user in the first instance has not been modified by determining that the first user's face has not been modified; and
create the reference data record for the first user that includes the face biometric reference signature in response to determining that the first user's face has not been modified.

18. The system of claim 16, wherein the additional reference signature, the additional event, and the current additional signature are a voice biometric reference signature, a voice biometric event, and a current voice biometric signature, respectively, and wherein the voice biometric reference signature represents the first user's voice.

19. The system of claim 18, wherein the computer-readable instructions cause the one or more processing units to:
determine that the first user's voice has not been modified in the first video stream; and
extract the voice biometric reference signature from the first video stream in response to determining that the first user's voice has not been modified in the first video stream.

20. The system of claim 16, wherein the additional reference signature, the additional event, and the current additional signature are a behavioral reference signature, a behavioral event, and a current behavioral signature, respectively, and wherein the behavioral reference signature indicates how the first user moves at least one of their face and their body.

21. The system of claim 16, wherein the additional reference signature, the additional event, and the current additional signature are a language pattern reference signature, a language pattern event, and a current language pattern signature, respectively, wherein the computer-readable instructions cause the one or more processing units to extract the language pattern reference signature from audio transcripts of at least one of the first video stream and one or more of the subsequent video streams, and wherein the language pattern reference signature indicates a frequency of specific words used by the first user.

22. The system of claim 16, wherein the additional reference signature, the additional event, and the current additional signature are an environmental reference signature, an environmental event, and a current environmental signature, respectively, and wherein the environmental reference signature represents visual characteristics associated with one or more of the first user's locations.

23. The system of claim 22, wherein the computer-readable instructions cause the one or more processing units to:
determine the first user's current location in the current video stream;
determine that the first user's current location does not match with the first user's current environmental signature; and
provide the first response based on the mismatch between the first user's current location and the first user's current environmental signature.

24. The system of claim 16, wherein the computer-readable instructions cause the one or more processing units to update the face biometric reference signature and the additional reference signature based on additional video streams that occur after the one or more subsequent video streams.

25. The system of claim 16, wherein the computer-readable instructions cause the one or more processing units to:
determine whether the first user's face in the current instance has been modified in the current video stream; and
provide the first response based on whether the first user's face in the current instance has been modified.

26. The system of claim 16, wherein the computer-readable instructions cause the one or more processing units to:
determine that the first user's face in the current instance has been modified in the current video stream;
determine that the modified first user's face matches a known second user's face associated with a stored face biometric reference signature for the second user; and
provide a second response to the security analyst device indicating that the current instance of the first user in the current video stream is an imposter that has modified their face to match the known second user's face.

27. The system of claim 16, wherein the first response indicates to the security analyst device that the current instance of the first user is an imposter when at least one of the face biometric event and the additional event is detected.

28. The system of claim 16, wherein a second response includes removing the first user from the current video meeting when at least one of the face biometric event and the additional event is detected.

29. The system of claim 16, wherein a second response includes notifying other users in the current video meeting that the first user is an imposter when at least one of the face biometric event and the additional event is detected.

30. The system of claim 16, wherein the computer-readable instructions cause the one or more processing units to modify the table based on input from the analyst device.
